(19) United States
(12) Patent Application Publication
(10) Pub. No.: US 2025/0378530 A1
(43) Pub. Date: Dec. 11, 2025

(54) METHOD FOR INCREASING THE RESOLUTION OF IMAGE LOGS IN REAL TIME

(71) Applicant: PETROLEO BRASILEIRO S.A. - PETROBRAS, Rio de Janeiro (BR)

(72) Inventors: Willian Andrighetto TREVIZAN, Rio de Janeiro (BR); Candida Menezes DE JESUS, Rio de Janeiro (BR)

(21) Appl. No.: 19/216,868

(22) Filed: May 23, 2025

(30) Foreign Application Priority Data
May 31, 2024 (BR) 1020240109465

(51) Int. Cl. G06T 3/4046; E21B 49/00; G01V 3/20; G01V 3/38; G06V 10/82; G06V 20/10

(52) U.S. Cl. CPC G06T 3/4046; E21B 49/00; G01V 3/20; G01V 3/38; G06V 10/82; G06V 20/10; E21B 2200/22

(57) ABSTRACT

The present invention relates to a computer-implemented method for real-time resolution enhancement of image logs during oil well drilling. The method is an AI model that increases the resolution of image logs in real time, during drilling, which allows the identification of geological structures such as faults and fractures even before the drill bit is removed from the well. It allows a better choice of the ranges that will be isolated during well completion. The invention can be applied to all drilled wells, wherein it is chosen to acquire image logs during drilling and it was developed to increase the resolution of fractured ranges or those with the presence of faults, but can be used by petrophysicists to perform a rapid interpretation of all identifiable geological structures.

### FIELD OF THE INVENTION

The present invention is part of the technical field of oil and gas, specifically related to well drilling and completion operations, more specifically related to modeling, simulation and evaluation of reservoirs, and refers to a method for increasing the resolution in real time of image logs during well drilling and completion operations.

### BACKGROUND OF THE INVENTION

In the process of evaluating a reservoir during well drilling, several physical properties are acquired from sensors that descend along the drilling column. These data are called loggings, and are used to understand reservoirs in terms of oil/gas storage capacity, permeability and production capacity, and to identify relevant geological structures.

In the current project management scenario, wherein agility and optimization of operations have been prioritized, the practice of logging while drilling (LWD) has gained ground compared to traditional cable logging. In theory, acquiring quality petrophysical properties during drilling brings greater agility in decision-making about well completion and optimizes operating costs.

One of these logs, the image log, uses acoustic or resistive transmitters and sensors to imaging the well wall, which allows the identification of textures and structures of the drilled reservoirs.

However, when data is acquired during well drilling, only a fraction of it is sent in real time to the surface rig, since there are limitations on the data bandwidth that can be transmitted. Therefore, in real time, only a highly undersampled and low-resolution image is available, which often does not allow for the identification of relevant structures.

The data available in real time contains about 50% (for resistive images) of the complete information, being insufficient for the identification of critical geological structures capable of impacting the communication between production or injection zones or the quality of cementation, such as fractures, caverns and geomechanical collapse zones.

Therefore, the complete data is only made available days after acquisition, following tool retrieval and data processing by the service provider. However, some geological structures such as faults and fractures directly affect decisions regarding the well completion process, decisions that must be made before drilling is completed.

In view of the above, in order to solve the limitations and technical problems described above, the present invention describes a computer-implemented method for increasing the resolution of image logs in real time. Therefore, an artificial intelligence (AI) algorithm was developed based on Generative Adversarial Neural Networks (GANs) that receives sub-sampled images as input in real time and generates corresponding high-resolution images, thus allowing the identification of these geological structures.

The AI model is trained using real-time image logs and the complete data retrieved after the image tool is removed from the well. The methodology can be applied to all wells that are drilled and that acquire image logs during drilling, and is part of the discipline of formation evaluation through logging.

The developed method represents a way to overcome telemetry limitations, where missing information is indirectly supplied by the artificial intelligence (AI) model, which the main learns characteristics of a field/reservoir. In this way, prior knowledge of the area can be used to continuously optimize future operations, efficiently incorporating the available database into the petrophysicists' workflow, for the recognition of geological and geomechanical structures in time to support decision-making in well completion operations.

### Prior Art

Documents describing methods similar to the present invention were identified. One of these convergences is the ultimate goal shared by all inventions: improving resolution or performing image analysis. However, it is important to highlight that, outside of these common points, the characteristics differ considerably.

The document WO2019055565A1 is part of the general state of the art and describes a method that includes receiving seismic image data, processing the received seismic image data to generate stratigraphic information using a neural network, and improving the seismic image data using the stratigraphic information to generate an improved seismic image.

In turn, the document US20220351403A1 is also part of the general state of the art and provides a method of detecting geological features using generative adversarial neural networks (GAN), in which seismic image data acquired for a underground formation from a data acquisition system are input into a deep neural network to generate fault detection data for the underground formation.

It is important to highlight that documents WO2019055565A1 and US20220351403A1, unlike the present invention, refer to seismic images. This data is generated from an acoustic impulse carried out on the planet's surface (or in the marine subsurface), and its reflection or transit times are detected by means of sensors spread across kilometer-sized grids on the planet's surface or in the marine subsurface, or along a well.

Therefore, the ‘low resolution’ referred to in the methodologies of these documents arises from a limitation inherent to the physics of wave acoustics itself. Geological structures such as reservoir stratigraphy, which occur on a metric and sub-metric scale, are invisible to this method. In this context, super resolution (or increased frequency content) consists of developing a methodology that starts from other types of data that detect characteristics at these smaller scales, and from then on “filling” the seismic data with the appropriate frequency content.

On the other hand, document CN108898560B is a super-resolution reconstruction method of CT (Computerized Tomography) image based on a three-dimensional convolutional neural network, the method basically comprises sending the images from the training set to a neural network, which according to the inventors, improves the resolution of three-dimensional CT images of rocks, recovers more structures and details, and provides clearer image samples for the next petroleum geological research.

Unlike the present invention, this document refers to a microtomographic image. This data is generated by bombarding a rock sample (of the order of a few centimeters) with X-ray beams. A measurement of the attenuation of the scattered beams is performed, and from the absorption detected in the different directions, a digital reconstruction of the sample is made using a density map. Therefore, super-resolution in this context has to do with overcoming these limitations of the physics of the method itself.

Finally, the document U.S. Pat. No. 9,939,548B2, which is also part of the general state of the art, describes a computer-implemented method having one or more computer programs stored therein. They are provided to improve well imaging analysis associated with a hydrocarbon reservoir. A neural network mapping process may first be executed, responding to open well log data and core data, in order to generate a material type scheme.

Like the present invention, this document deals with petrophysical analyses in image logs. However, it does not address the issue of super resolution. This document presents automated methodologies for interpretation, calibration and generation of other petrophysical properties (such as facies and rock typing) from image logs, including model propagation, but it does not address improving the quality of the images themselves.

Thus, considering the above, it is possible to perceive relevant differences in the solutions presented in the state of the art in relation to the present invention and it is still possible to verify the presence of a differential technical effect in the present invention, considering not only the intrinsic advantages of the method, but also differences in the application focus.

In short, the essential issue addressed in the present invention is that, during well drilling and acquisition of image log data, it is not possible to send the entire image to the base where the data interpretation will occur. Due to a communication bandwidth limitation, only a partial, subsampled image is sent to the base in real time (during drilling).

The full image is only accessible after the end of drilling, when the sensors are removed from the well, and therefore access to the full image cannot be done in real time (during drilling). The present method therefore proposes to reconstruct the total image that is acquired, from the partial image that arrives at the base in real time.

It is important to highlight that the present invention confers advantages and it can be applied to all wells that are drilled and that acquire image logs during drilling. Correct identification of faults and fractures in real-time logging is essential to perform a type of well completion, called intelligent open well completion, where several production or injection zones are isolated, ensuring the productive performance of the field.

### BRIEF DESCRIPTION OF THE INVENTION

The present invention relates to a computer-implemented method for real-time resolution enhancement of image logs during oil well drilling. The method is an AI model that increases the resolution of image logs in real time, during drilling, which allows the identification of geological structures such as faults and fractures even before the drill bit is removed from the well. It allows a better choice of the ranges that will be isolated during well completion. The invention can be applied to all drilled wells, wherein it is chosen to acquire image logs during drilling and it was developed to increase the resolution of fractured ranges or those with the presence of faults, but can be used by petrophysicists to perform a rapid interpretation of all identifiable geological structures.

### BRIEF DESCRIPTION OF THE FIGURES

In order to obtain a complete and total view of the object of this invention, the figures to which references are made below are presented.

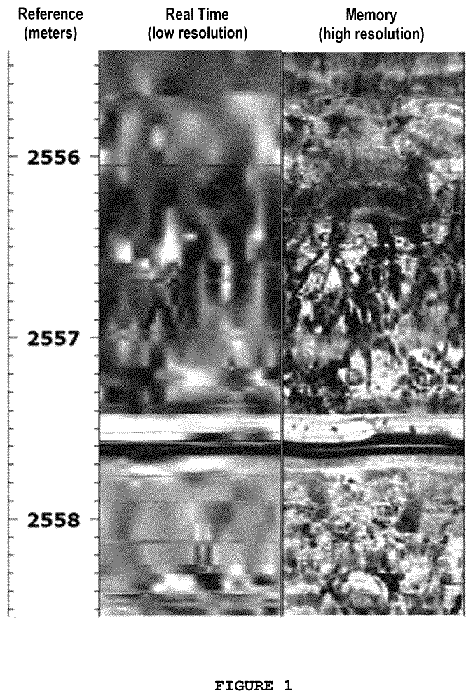

In FIG. 1 it is schematically represented a real-time resistive image log (left) and corresponding memory resistive image (right).

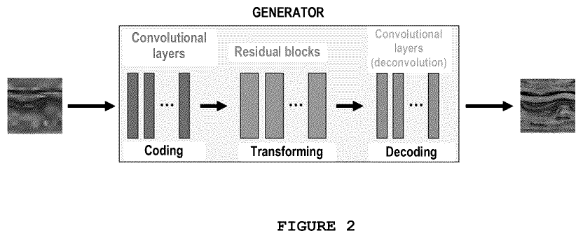

In FIG. 2 it is showed a schematic view of a deep neural network called Generator, which aims to receive low-resolution images and generate corresponding high-resolution images.

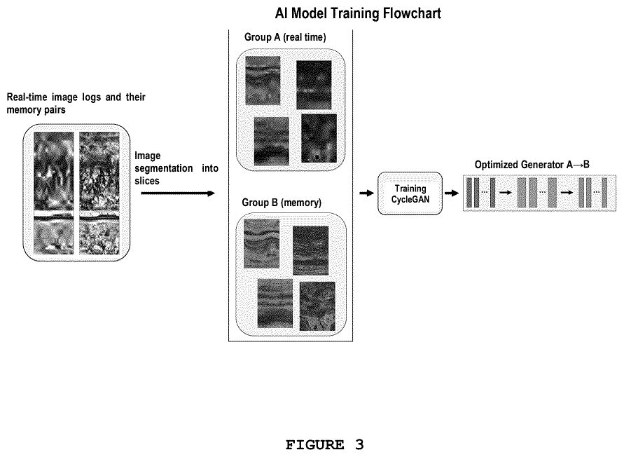

In FIG. 3 it is schematically represented the training/optimization flowchart of the AI model, consisting of obtaining real-time and memory image logs, separating the images into slices of approximately 1 meter in low and high resolution groups, and training using the CycleGAN algorithm.

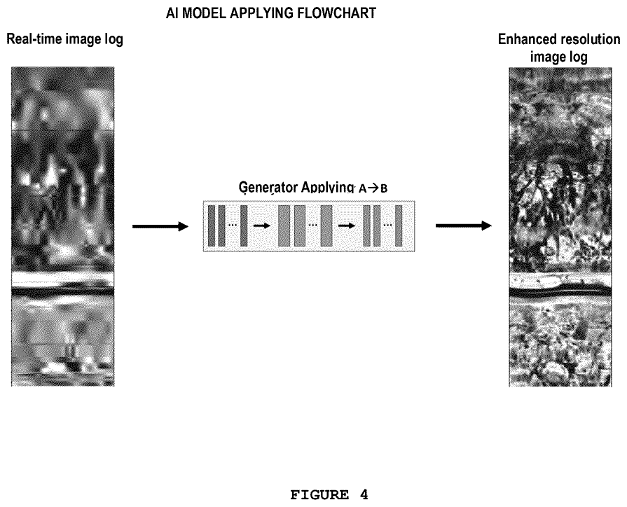

In FIG. 4 it is schematically represented the flowchart for applying the AI model to a well during drilling. The low-resolution real-time image log is received on the surface, and Generator A→B trained to generate a corresponding high-resolution image is applied.

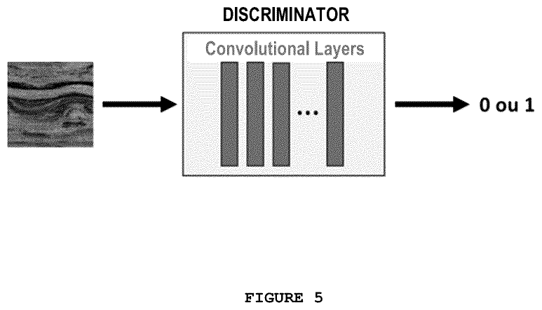

In FIG. 5 it is showed a schematic view of a deep neural network called Discriminator, which aims to receive an image as input and return the number 1 if this image comes from a real image log data, or 0 if it comes from an image created by a Generator.

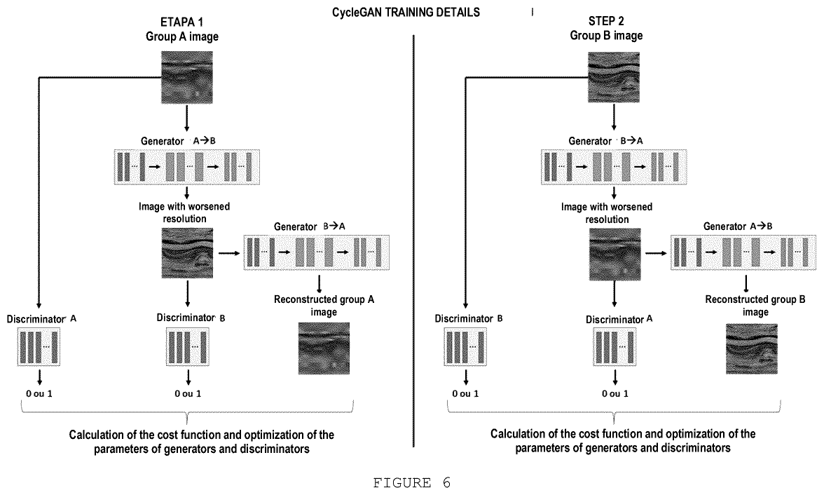

In FIG. 6 it is represented a flowchart with a detailed view of the training/optimization process of the algorithm known in the literature as CycleGAN, where the generators and discriminators are optimized together.

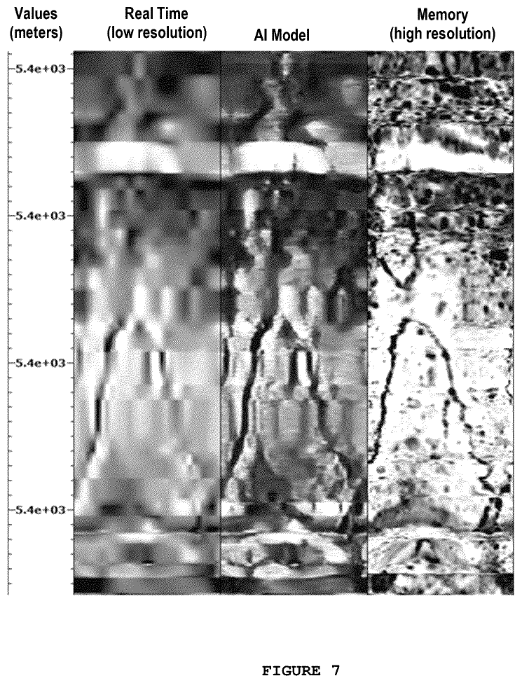

In FIG. 7 it is represented, respectively, the real-time image log record (low resolution), the result of the AI model, and the memory image log (high resolution), showing the increased resolution of a fracture.

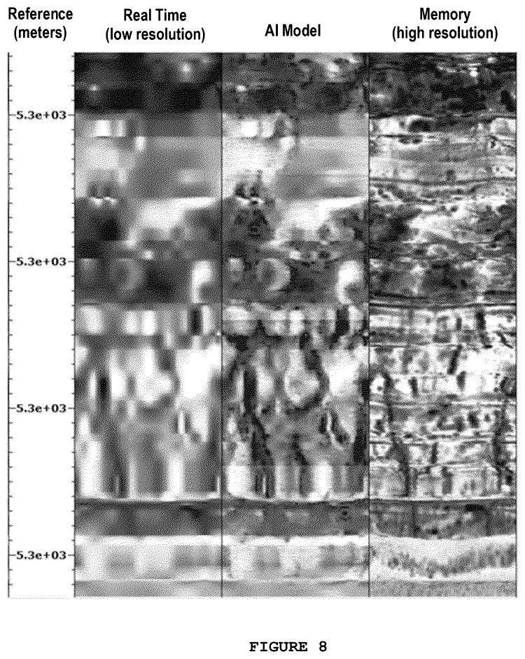

In FIG. 8 it is represented respectively the real-time image log record (low resolution), the result of the AI model, and the memory image log (high resolution), showing the transition between a porous range and a fractured range.

### DETAILED DESCRIPTION OF THE INVENTION

The present invention relates to a computer-implemented method for real-time resolution enhancement of image logs during oil well drilling. The method is an AI model based on Generative Adversarial Neural Networks (GANs), which increases the resolution of image logs in real time, during drilling, which allows the identification of geological structures such as faults and fractures even before the drill bit is removed from the well.

As shown in FIG. 1, although it is possible to acquire and transmit well information and image data in real time, due to transmission bandwidth limitations, the data transmitted to the surface during drilling (real-time log) is undersampled, containing about 50% of the total data acquired and stored in the logging tool memory (memory log).

As can be seen in FIG. 1, real-time data does not have the resolution necessary to allow the recognition of geological and geomechanical structures that are critical for the isolation of production or injection zones.

The increase in resolution is achieved through the optimization of a deep neural network that aims to receive as input the low-resolution real-time image and deliver at the output a corresponding image that resembles the image of memory log, i.e., high resolution (step a). This neural network will be called Generator, and its schematic structure is described in FIG. 2.

As shown in FIG. 2, the generator consists of three modules that process the input image sequentially. The first, the encoding one, consists of a sequence of convolutional neural networks. The second, the transformation one, is made up of a sequence of residual blocks. The third module, responsible for generating the final image, consists of another sequence of convolutional network layers.

FIG. 2 is just a representation of a typical generator structure, which may vary in the number or type of layers used.

When the generator is optimized to receive low resolution images (real-time log) and return corresponding high resolution images, it is called Generator A→B. When the generator is optimized to receive high resolution images (memory log) and return low resolution images, we call it Generator B→A.

The method can be described by the following macro-steps. a) Gathering or Selecting a set of real-time image logs (low resolution), and their corresponding memory logs (high resolution). b) Slicing the logs into images of approximately 1 meter in length, each. c) Separating the resulting images into two groups: Group A, containing only low-resolution images from the real-time logs, and Group B, containing only high-resolution images from the memory logs. d) Optimizing the Generator A→B using the methodology known in the literature as CycleGAN, using images from groups A and B. e) Applying the Generator A→B for increasing the resolution of real-time image logs, in new image log acquisitions during the drilling of a new well.

The macro-steps of a) to d) are schematically represented in the flowchart of FIG. 3, which shows a typical example of real-time image log and its memory pair, a representation of the sliced images separated into groups A and B, which serve as input for the CycleGAN algorithm for training a Generator A→B optimized.

In FIG. 4 we see a schematic flowchart of macro-step e). In a real oil well drilling operation and acquiring an image log during drilling, a subsampled version of the acquired data is sent to the surface, generating a low-resolution real-time log. This log serves as input to Generator A→B optimized on a database from previous wells (steps a) to d), which generates an image log with improved resolution.

In a conventional generative adversarial network (GAN) scheme widely available in the literature, together with the Generator, another deep neural network called the Discriminator is optimized. The Discriminator receives an image as input, and returns the number 1 at the output, if its processing identifies the input as a real image, or the number 0, if it identifies the input as an image artificially generated by a Generator.

When the Discriminator is optimized to identify images from group A (low-resolution real-time images), we call it Discriminator A. When the Discriminator is optimized to identify images from group B (high-resolution memory images), we call it Discriminator B.

FIG. 5 shows a schematic representation of a typical Discriminator, consisting of a sequence of convolutional layers that receive an image as input and return the number 0 or 1 at the output. The number and type of layers used in the discriminator can vary.

In the method described herein, the training/optimization of Generator A→B was implemented in the programming language Python, following the CycleGAN algorithm, available in the literature and briefly described in FIG. 6. As shown in FIG. 6, in the first step (Step a) we start with an image from group A, from which three results are generated: 1) The result of Discriminator A; 2) The result of the sequential application of Generator A→B followed by Discriminator B; 3) The result of the sequential application of Generator A→B followed by Generator B→A. The three results are summarized by a math function called the cost function.

There are numerous versions of cost functions available in the literature, and the method described here deals with the use of CycleGAN to increase the resolution of real-time image logs, regardless of the specific form of the cost function used.

The parameters of the Generator and Discriminator layers are modified by a process known in the literature as backpropagation, so that the cost function is modified in order to increase the accuracy rate of the discriminators and increase the quality of the images created by the generators.

In Step b) an analogous process is carried out starting from an image from group B, also illustrated in FIG. 6. The sequential applying of steps a) and b) is carried out by going through all the images in groups A and B, as many times as necessary until the optimization of the generators and discriminators stabilizes.

The image data used in the present invention were acquired in oil wells drilled using a water-based conductive drilling mud, through sensors that measure the resistivity of the well wall according to the lateral log principle, where an electrical voltage is applied to a measuring electrode, causing the flow of an electrical current.

To keep the electrical flow focused through the rock formation, it also applies the same electrical voltage to the protective electrodes near the measuring electrode. The apparent resistivity of the rock formation, recorded by the tool, is proportional to the measured resistance. More resistive regions of the well wall are usually shown in lighter colors, and less resistive regions in darker colors.

As described in the AI model training macro-steps (illustrated in FIG. 3), these logs were segmented into slices of approximately 1 m in length, generating low-resolution images of 166×64 pixels (from the real-time logs), and their pairs of high-resolution images, of 166×120 pixels (from the memory logs).

Approximately 10% of the resulting images were separated and not used in model training, so that their performance could be evaluated in ranges not used in optimization. The remaining images were separated into groups A and B (respectively low-resolution real-time images and high-resolution memory images).

Generator A→B was optimized using the CycleGAN training algorithm.

FIG. 7 shows the result of applying the AI model (Generator A→B) in a range not used for model training/optimization, and which has a very well-defined fracture feature between the reference depths of 2156.8 m and 2157.8 m. In the left track we have the real-time image log (low resolution), in the right track we have the corresponding memory log (high resolution), and the result of applying the AI model in the central track.

The reinforcement of the fracture can be seen in the central trail, increasing the contrast and allowing a better definition of this geological feature. In the upper zone, which consists predominantly of a vugular zone, the result of the AI model maintained a textural characteristic of cavities, and not fractures.

Another example of the AI model's performance in a range not used in training can be seen in FIG. 8, which has a fractured zone between the reference depths of 2046.5 m and 2047.7 m. Although the results of the AI model do not show the fractures as well defined as in the case of FIG. 7, it is possible to clearly see the change in texture between the upper, more vugular zone, and the fractured zone.

The developed models show a promising solution for improving the resolution of real-time image logs, which can be used to support decision-making regarding well completion strategies. The results show that it is possible to implement a continuous improvement in the quality of the generating network, incorporating data from new drilled wells into the model's training set.

The results indicate that the images generated by the AI model increase the resolution of important geological structures (such as faults and fractures) for decision-making, while respecting the original geometric characteristics observed in the low-resolution log. It is therefore important that the database used to train the model presents a comprehensive set of features that you want to reproduce.

Finally, strategies such as the one described here easily allow the extension of the method to incorporate other data sources acquired in oil wells, such as density loggings, gamma rays, and others.

Those skilled in the art will value the knowledge presented herein and will be able to reproduce the invention in the presented embodiments and in other variants, covered in the scope of the appended claims.

1. A method for increasing a resolution of image logs, wherein the method comprises the steps of:
selecting a set of low-resolution real-time image logs and their corresponding high-resolution memory logs;
slicing the real-time image logs and the corresponding high-resolution memory logs into images of approximately 1 meter long;
separating the images into two groups, wherein the two groups are group A and group B, wherein group A contains low-resolution images from the real-time image logs, and wherein group B contains high-resolution images from the memory logs;
optimizing a deep neural network using the low-resolution images from group A and the high-resolution images from group B, wherein the deep neural network is Generator A→B with CycleGAN; and
applying Generator A→B with CycleGAN for increasing to increase the resolution of the real-time image logs in new image log acquisitions during drilling of a new well.

2. The method of claim 1, wherein the method is based on Generative Adversarial Neural Networks.

3. The method of claim 1, wherein the method carries out an identification of geological structures.

4. The method of claim 1, wherein the deep neural network is configured to receive as input the low-resolution images and output corresponding high-resolution images.

5. The method of claim 4, wherein the Generator A→B with CycleGAN comprises three modules configured to process the input low-resolution images sequentially.

6. The method of claim 4, wherein:
the first module of the Generator A→B with CycleGAN is an encoding module, consisting of a first sequence of convolutional neural networks,
the second module of the Generator A→B with CycleGAN is a transformation module, consisting of a sequence of residual blocks, and
the third module of the Generator A→B with CycleGAN is configured to generate a final image, consisting of a second sequence of convolutional network layers.

7. The method of claim 1, wherein:
when the deep neural network is optimized to receive low-resolution images and return corresponding high-resolution images, the deep neural network is called Generator A→B, and
when the deep neural network is optimized to receive high-resolution images and return low-resolution images, the deep neural network is called Generator B→A.

8. The method of claim 1, wherein the deep neural network is a first deep neural network, and wherein a second deep neural network is optimized, wherein the second deep neural network is referred to as Discriminator.

9. The method of claim 8, wherein the Discriminator is configured to receive an image as input and return a number 1 at the output if the Discriminator identifies the input as a real image, or a number 0 if the Discriminator identifies the input as an image artificially generated by the Generator A→B with CycleGAN.

10. The method of claim 8, wherein:
when the Discriminator is optimized to identify images from group A or low-resolution real-time images, it is called Discriminator A, and
when the Discriminator is optimized to identify images from group B or high-resolution memory images, it is called Discriminator B.

11. The method of claim 1, wherein the optimization of Generator A→B with CycleGAN is implemented in the programming language Python following a CycleGAN algorithm.

12. The method of claim 8, wherein the parameters of the Generator A→B with CycleGAN and Discriminator layers are modified so that a cost function is modified.

13. The method of claim 8, wherein the method further comprises sequential applying the selecting and slicing steps by going through all the images in group A and group B until the optimization of the Generator A→B with CycleGAN and the Discriminator stabilizes.

14. The method of claim 3, wherein the geological structures are faults and fractures.
